(19) United States
(12) Patent Application Publication
(10) Pub. No.: US 2025/0386928 A1
(43) Pub. Date: Dec. 25, 2025

(54) CABINET

(71) Applicant: LG ELECTRONICS INC., Seoul (KR)

(72) Inventors: Jiho LEE, Seoul (KR); Kangsuk LEE, Seoul (KR); Sunghwan OH, Seoul (KR); Myoungku LEE, Seoul (KR); Suk KO, Seoul (KR)

(73) Assignee: LG ELECTRONICS INC., Seoul (KR)

(21) Appl. No.: 18/890,593

(22) Filed: Sep. 19, 2024

(30) Foreign Application Priority Data
Jun. 21, 2024 (KR) 10-2024-0080895

(51) Int. Cl. A47B 55/00; A47B 96/14

(52) U.S. Cl. CPC A47B 55/00; A47B 96/1466

(57) ABSTRACT

A cabinet includes a case having an accommodation space formed therein and having an open front, and a reinforcing member coupled to an inner surface of the case and configured to increase structural rigidity of the case, wherein the reinforcing member includes a pair of lateral reinforcing members arranged upright and spaced apart from each other in a first direction, a top reinforcing member disposed at an upper end of the pair of lateral reinforcing members, and a bottom reinforcing member disposed at a lower end of the pair of lateral reinforcing members and increases the structural rigidity of the case through a reinforcing member coupled to an inner surface of the case.

### CROSS-REFERENCE TO RELATED APPLICATION(S)

Pursuant to 35 U.S.C. § 119, this application claims the benefit of earlier filing date and right of priority to Korean Application No(s). 10-2024-0080895, filed on Jun. 21, 2024, the contents of which are all incorporated by reference herein in its entirety.

### TECHNICAL FIELD

The present disclosure relates to a cabinet for increasing the structural rigidity of a case through a reinforcing member coupled to an inner surface of the case.

### BACKGROUND

In general, an electric vehicle (EV) has not been put into practical use for a long time because of problems such as a great weight of a battery mounted in the vehicle and a time it takes to charge when compared to a gasoline or diesel vehicle. However, recently, because of a depletion of fossil energy and environmental pollution, interest in the electric vehicle that does not use the fossil energy but uses electric energy has increased, and research and development on the electric vehicle have been actively conducted.

As a result, popularization of the electric vehicle has been increasing recently. The electric vehicle has a battery that supplies power for operation thereof, and has a structure in which the power is stored in the battery. Therefore, to continuously operate the electric vehicle, the battery must be charged. Accordingly, an infrastructure for charging the electric vehicle is needed, and fixed standing charging facilities are being established in various locations to meet an increasing demand for the electric vehicle.

To install electric vehicle charging facilities in various locations, a box-shaped cabinet containing a plurality of electronic components, including power modules, needs to be moved to an installation location. To this end, a ring-shaped eyebolt is fastened to an upper surface of the cabinet, and a wire or the like are connected to the eyebolt to move the cabinet.

However, in a process of moving the cabinet, a significant load is applied to the cabinet. In consideration of the box-shaped shape of the cabinet for mounting a plurality of electronic components, including power modules, there is a very high risk that the cabinet is to be damaged by the load applied to the cabinet during movement. For example, during a process of lifting the cabinet, the cabinet may bend or twist under the load and be damaged.

To ensure an infrastructure for charging electric vehicles, it is necessary to ensure a sufficient space to install charging facilities for electric vehicles, but there are limits to expanding the installation space in public buildings, park parking lots, highway rest areas, and apartment complexes.

Accordingly, to resolve the above-mentioned problem, there is a need for a device that ensure the structural rigidity of the cabinet and escape restrictions on installation space.

### SUMMARY

The present disclosure relates to a cabinet, and more particularly, to a cabinet for increasing the structural rigidity of a case through a reinforcing member coupled to an inner surface of the case.

The present disclosure provides a cabinet advantageous in ensuring an installation space by reducing the size of a case while improving aesthetics through a shape of a case and rear arrangement of a blower.

The objects to be achieved by the inventive concept are not limited to the technical objects described above and other objects that are not stated herein will be clearly understood by those skilled in the art from the following specifications.

A cabinet includes a case having an accommodation space formed therein and having an open front, and a reinforcing member coupled to an inner surface of the case and configured to increase structural rigidity of the case, wherein the reinforcing member includes a pair of lateral reinforcing members arranged upright and spaced apart from each other in a first direction, a top reinforcing member disposed at an upper end of the pair of lateral reinforcing members, and a bottom reinforcing member disposed at a lower end of the pair of lateral reinforcing members.

The reinforcing member may include a coupling surface in contact with the inner surface of the case, and a support surface perpendicularly bent from the coupling surface and protruding from the inner surface of the case.

The reinforcing member may include a C-shaped cross section.

The reinforcing member may be configured as a plurality of reinforcing members that are spaced apart from each other in a second direction perpendicular to the first direction and coupled to the inner surface of the case.

The case may include a plurality of fastening grooves formed on an upper surface thereof and spaced apart from each other in the first direction and the second direction, and the plurality of reinforcing members may be coupled to the inner surface of the case such that the top reinforcing member is located at positions corresponding to the plurality of fastening grooves.

At least one of the plurality of reinforcing members may include a first intermediate reinforcing member located in parallel to the top reinforcing member and the bottom reinforcing member between the pair of lateral reinforcing members.

At least one of the plurality of reinforcing members may include a second intermediate reinforcing member located perpendicular to the first intermediate reinforcing member.

The cabinet may further include a shelf member having one end inserted into the second intermediate reinforcing member and located in the second direction.

The shelf member may include a shelf surface protruding in the first direction on one surface of the shelf member.

The cabinet may further include an additional reinforcing member located between the plurality of reinforcing members and coupled to the inner surface of the case.

The additional reinforcing member may include a first additional reinforcing member coupled to the pair of lateral reinforcing members and located in the second direction, and a second additional reinforcing member located perpendicular to the first additional reinforcing member.

The additional reinforcing member may include a third additional reinforcing member located perpendicular to the first additional reinforcing member and the second additional reinforcing member.

Reinforcing members may be coupled to each other through bolt fastening.

The case may include a roof extending from an upper surface of the case and protruding forward, a rib that protruding forward from a circumference of a front surface of the case; and a door having an upper surface in contact with a lower surface of the roof and inserted into the rib.

A front surface of the roof and a front surface of the door inserted into the rib may define an identical plane.

The cabinet may further include a sealing member coupled to the rib along an outer surface thereof and configured to block a gap between the rib and door inserted into the rib.

The case may include a rear cover having an opening formed therein, and an exhaust bracket coupled to the rear cover and covering the opening, and the exhaust bracket may include an exhaust hole that is inclined downward.

The cabinet may further include a blower located inside the exhaust bracket and configured to exhaust heat generated from electronic components mounted in the accommodation space through the exhaust hole.

The cabinet may further include a fixing plate coupled to the rear cover and fixing the blower, and a fixing bracket coupled to the exhaust bracket and the fixing plate and covering the blower.

The exhaust hole may be configured as a plurality of exhaust holes that are spaced apart from each other and formed on a front surface and a lateral surface of the exhaust bracket.

### BRIEF DESCRIPTION OF THE DRAWINGS

Embodiments will be more clearly understood from the following detailed description taken in conjunction with the accompanying drawings in which:

FIG. 1 is a diagram showing a shape of a case in a cabinet according to an embodiment of the present disclosure;

FIG. 2 is a diagram to explain the characteristics of increasing the structural rigidity of a case through a reinforcing member in a cabinet according to an embodiment of the present disclosure;

FIG. 3. is an exploded diagram showing a reinforcing member in a cabinet according to an embodiment of the present disclosure;

FIG. 4 is a diagram illustrating an area A of FIG. 2;

FIG. 5 is a diagram illustrating an area B of FIG. 2;

FIG. 6 is a perspective view including a cross section C-C of FIG. 2;

FIG. 7 is a diagram illustrating a structure in which a first intermediate reinforcing member and a second intermediate reinforcing member are arranged in a cabinet according to an embodiment of the present disclosure;

FIG. 8 is a diagram showing a shape of a first intermediate reinforcing member in a cabinet according to an embodiment of the present disclosure;

FIG. 9 is a diagram illustrating a cabinet according to an embodiment of the present disclosure;

FIG. 10 is a diagram showing a shelf member in a cabinet according to an embodiment of the present disclosure;

FIG. 11 is a diagram showing a shape of a first additional reinforcing member in a cabinet according to an embodiment of the present disclosure;

FIG. 12 is a diagram showing a shape of a second additional reinforcing member in a cabinet according to an embodiment of the present disclosure;

FIG. 13 is a side view of a cabinet according to an embodiment of the present disclosure;

FIG. 14 is a perspective view of a cabinet according to an embodiment of the present disclosure; and

FIG. 15 is an exploded view of a structure of a rear cover in a cabinet according to an embodiment of the present disclosure.

### DETAILED DESCRIPTION

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

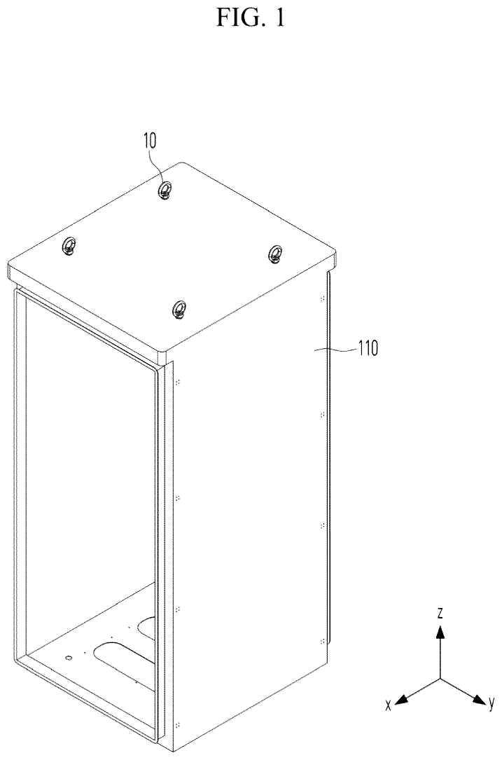

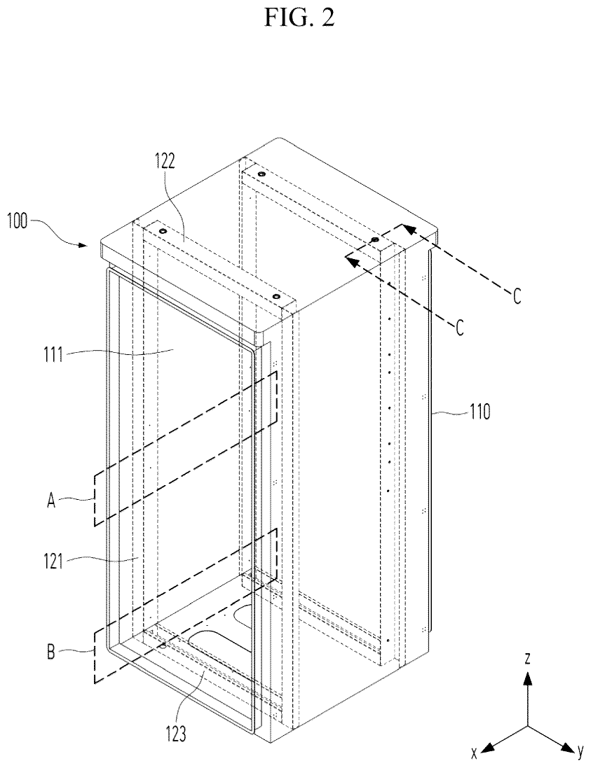

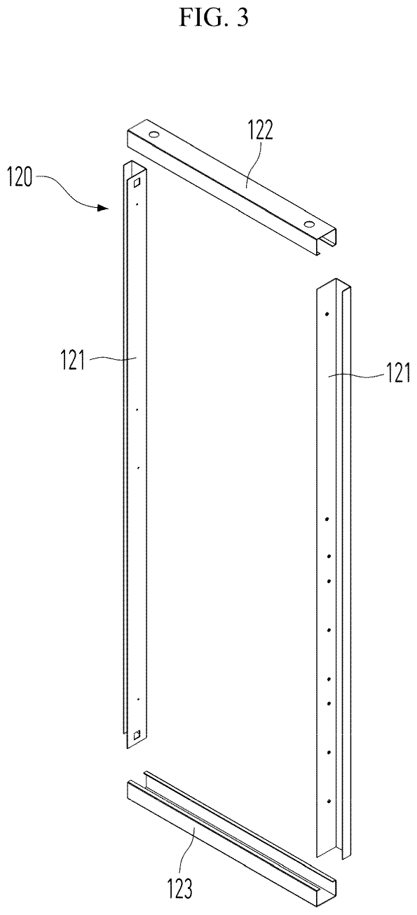

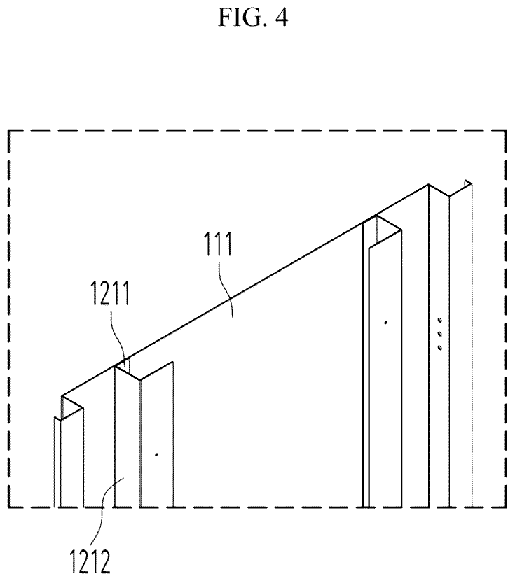

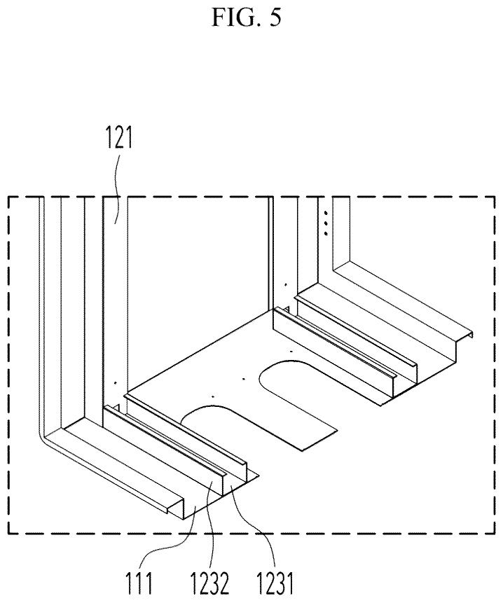

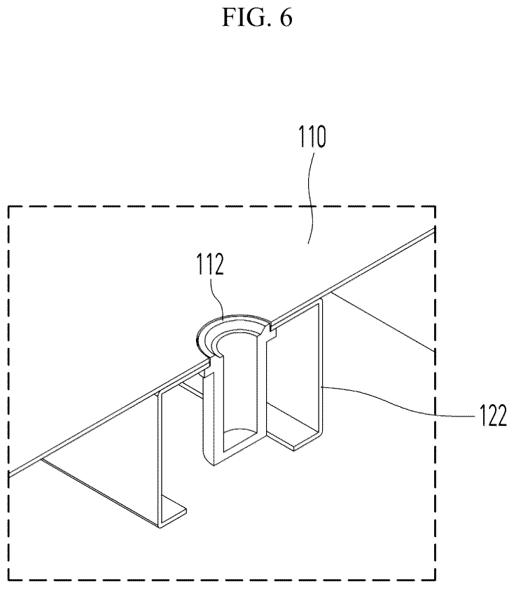

FIG. 1 is a diagram showing a shape of a case 110 in a cabinet 100 according to an embodiment of the present disclosure. FIG. 2 is a diagram to explain the characteristics of increasing the structural rigidity of a case 110 through a reinforcing member 120 in the cabinet 100 according to an embodiment of the present disclosure. FIG. 3. is an exploded diagram showing the reinforcing member 120 in the cabinet 100 according to an embodiment of the present disclosure. FIG. 4 is a diagram illustrating an area A of FIG. 2. FIG. 5 is a diagram illustrating an area B of FIG. 2. FIG. 6 is a perspective view including a cross section C-C of FIG. 2.

Hereinafter, in describing the cabinet 100 according to an embodiment of the present disclosure, front and rear directions will be described based on the x-axis direction, left and right directions will be described based on the y-axis direction, and up and down directions will be described based on the z-axis direction.

Referring to FIGS. 1 and 2 together, the cabinet 100 according to an embodiment of the present disclosure may include the case 110 and the reinforcing member 120. First, the case 110 may have an accommodation space formed therein and may have an open front. A plurality of electronic components, including a power module, may be installed in the accommodation space.

As described above, to install an electric vehicle charging facility in various locations, the case 110 having a box shape as shown in FIG. 1 needs to be moved to the installation location. To this end, an eyebolt 10 having a ring shape is fastened to an upper surface of the case 110, and a wire or the like are connected to the eyebolt 10 to move the case 110.

However, in a process of moving the case 110, a significant load is applied to the case 110. In consideration of the shape of the cabinet for mounting the plurality of electronic components, including the power module, there is a very high risk that the case 110 is to be damaged by the load applied to the case 110 during movement. For example, during a process of lifting the case 110, the case 110 may bend or twist under the load and be damaged.

Accordingly, the cabinet 100 according to an embodiment of the present disclosure may include the reinforcing member 120 coupled to an inner surface 111 of the case 110, as shown in FIG. 2. Here, the reinforcing member 120 may increase the structural rigidity of the case 110.

In more detail, referring to FIGS. 2 and 3 together, in the cabinet 100 according to an embodiment of the present disclosure, the reinforcing member 120 may include a pair of lateral reinforcing members 121, a top reinforcing member 122, a bottom reinforcing member 123.

The pair of lateral reinforcing members 121 may be arranged upright and spaced apart from each other in a first direction (y-axis direction), and may be coupled to both lateral surfaces of the inner surface 111 of the case 110. The top reinforcing member 122 may be disposed at an upper end of the pair of lateral reinforcing members 121 and may be coupled to an upper surface of the inner surface 111 of the case 110. The bottom reinforcing member 123 may be disposed at a lower end of the pair of lateral reinforcing members 121 and may be coupled to a lower surface of the inner surface 111 of the case 110.

That is, the reinforcing member 120 may have the pair of lateral reinforcing members 121, the top reinforcing member 122, and the bottom reinforcing member 123 that have a rim shape and may be coupled to the inner surface 111 of the case 110.

Through this, in the cabinet 100 according to an embodiment of the present disclosure, a wire or the like may be connected to the eyebolt 10 located on the upper surface of the case 110 through the reinforcing member 120 having a rim shape coupled to the inner surface 111 of the case 110, thereby increasing the structural rigidity of the case 110 when the case 110 is moved.

That is, in a process of lifting the case 110, the case 110 may be prevented from bending or twisting through the reinforcing member 120 coupled to the inner surface 111 of the case 110, and through this, a possibility of damage to the case 110 may be reduced.

In the cabinet 100 according to an embodiment of the present disclosure, a plurality of reinforcing members 120 may be spaced apart from each other in a second direction (x-axis direction) perpendicular to a first direction (y-axis direction) and may be coupled to the inner surface 111 of the case 110, as shown in FIG. 2. Through this, the structural rigidity of the case 110 described above may be further increased.

Referring to FIGS. 1 and 6 together, in the cabinet 100 according to an embodiment of the present disclosure, the case 110 may include a plurality of fastening grooves 112 formed on the upper surface thereof and spaced apart from each other in the first direction (y-axis direction) and the second direction (x-axis direction). The eyebolt 10 may be fastened to the upper surface of the case 110 through the plurality of fastening grooves 112.

In particular, in the cabinet 100 according to an embodiment of the present disclosure, a plurality of reinforcing members 120 may be coupled to the inner surface 111 of the case 110 such that the top reinforcing member 122 is located at positions corresponding to the plurality of fastening grooves 112. In this case, referring to FIG. 3 together, grooves into which the eyebolt 10 is to be fastened may be formed at positions of the top reinforcing member 122, which correspond to the plurality of fastening grooves 112.

Through this, when a wire or the like is connected to the eyebolt 10 coupled to the plurality of fastening grooves 112 to move the case 110, the structural rigidity of the case 110 may be increased by the top reinforcing member 122 coupled to the inner surface 111 of the case 110, the pair of lateral reinforcing members 121 coupled to the top reinforcing member 122, and the bottom reinforcing member 123 coupled to the pair of lateral reinforcing members 121.

Referring to FIGS. 4 and 5 together, in the cabinet 100 according to an embodiment of the present disclosure, the reinforcing member 120 may include coupling surfaces 1211 and 1231 in contact with the inner surface 111 of the case 110, and support surfaces 1212 and 1232 that are perpendicularly bent from the coupling surfaces 1211 and 1231 and protrude from the inner surface 111 of the case 110. The reinforcing member 120 may include a C-shaped cross section.

That is, in the cabinet 100 according to an embodiment of the present disclosure, the reinforcing member 120 may be coupled to the inner surface 111 of the case 110 through the coupling surfaces 1211 and 1231. For example, the coupling surfaces 1211 and 1231 may be welded to the inner surface 111 of the case 110.

The support surfaces 1212 and 1232 may be formed by bending perpendicularly from the coupling surfaces 1211 and 1231, thereby preventing the case 110 from being bent or twisted through the support surfaces 1212 and 1232. When coupled to each other, the pair of lateral reinforcing members 121, the top reinforcing member 122, and the bottom reinforcing member 123 may be coupled to each other through the support surfaces 1212 and 1232, thereby increasing the structural rigidity of the case 110.

The reinforcing member 120 according to an embodiment of the present disclosure may include a C-shaped cross section to more firmly support the inner surface 111 of the case 110, thereby further increasing the structural rigidity of the case 110.

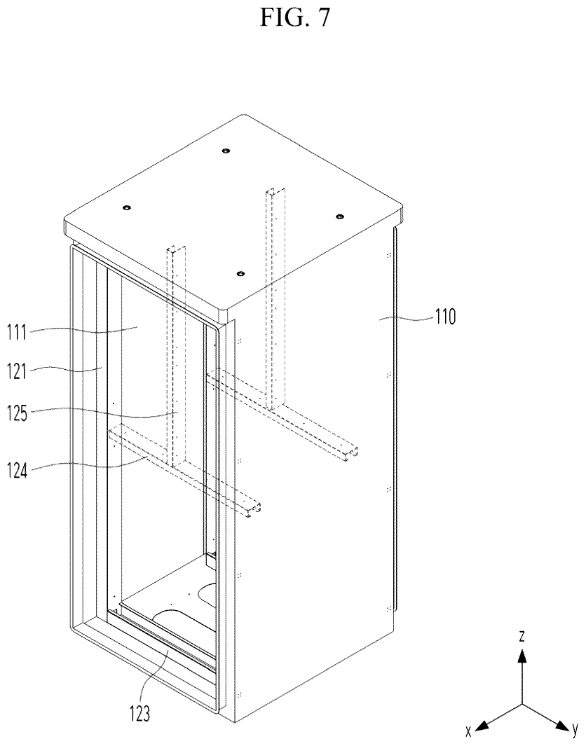

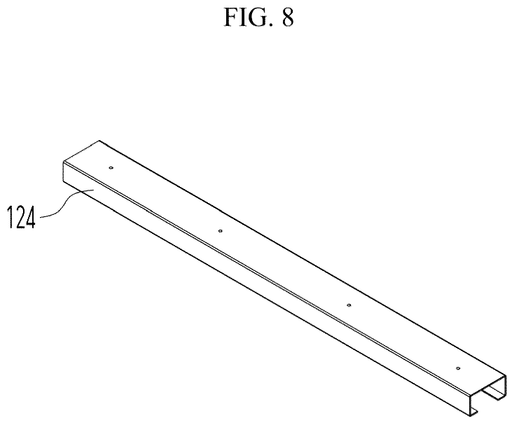

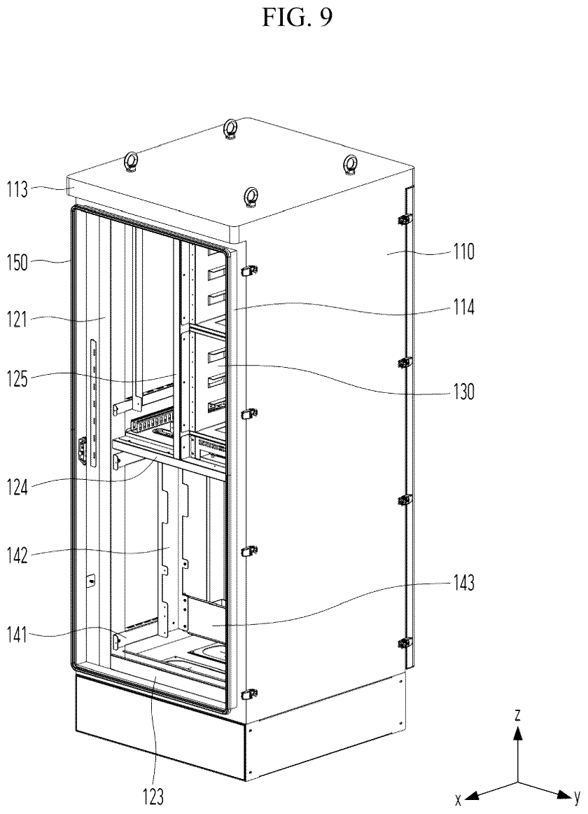

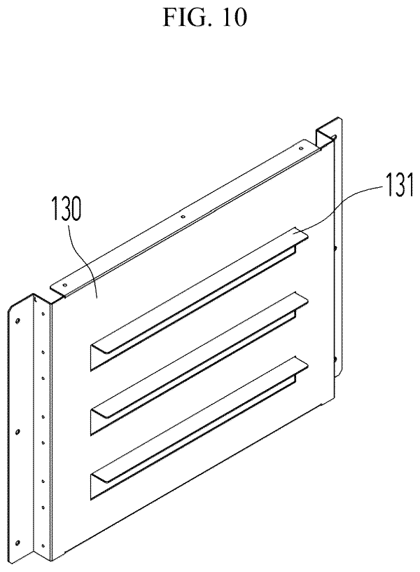

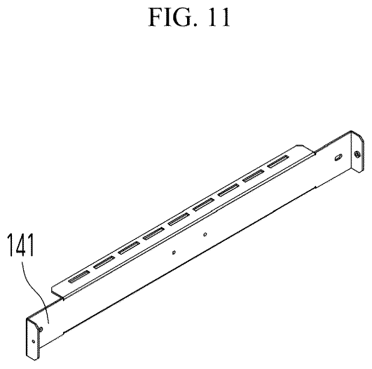

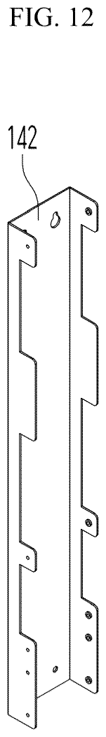

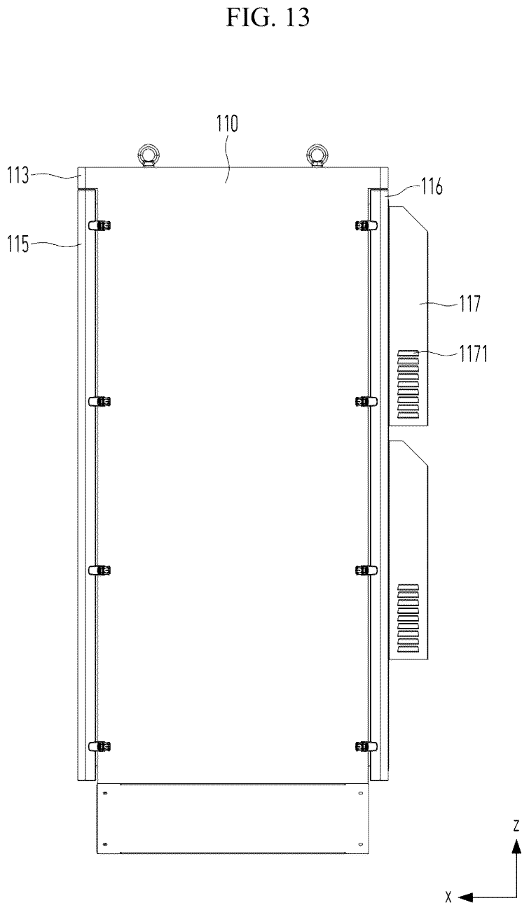

FIG. 7 is a diagram illustrating a structure in which a first intermediate reinforcing member 124 and a second intermediate reinforcing member 125 are arranged in the cabinet 100 according to an embodiment of the present disclosure. FIG. 8 is a diagram showing a shape of the first intermediate reinforcing member 124 in the cabinet 100 according to an embodiment of the present disclosure. FIG. 9 is a diagram illustrating the cabinet 100 according to an embodiment of the present disclosure. FIG. 10 is a diagram showing a shelf member 130 in the cabinet 100 according to an embodiment of the present disclosure. FIG. 11 is a diagram showing a shape of a first additional reinforcing member 141 in the cabinet 100 according to an embodiment of the present disclosure. FIG. 12 is a diagram showing a shape of a second additional reinforcing member 142 in the cabinet 100 according to an embodiment of the present disclosure. FIG. 13 is a side view of the cabinet 100 according to an embodiment of the present disclosure.

As described above with reference to FIG. 2, in the cabinet 100 according to an embodiment of the present disclosure, a plurality of reinforcing members 120 may be spaced apart from each other in the second direction (x-axis direction) to be coupled to the inner surface 111 of the case 110. In this case, the plurality of reinforcing members 120 may be coupled to the inner surface 111 of the case 110 such that the top reinforcing member 122 is located at positions corresponding to the plurality of fastening grooves 112.

Referring to FIG. 7 together, in the cabinet 100 according to an embodiment of the present disclosure, at least one of the plurality of reinforcing members 120 may include the first intermediate reinforcing member 124 located in parallel to the top reinforcing member 122 and the bottom reinforcing member 123 between the pair of lateral reinforcing members 121. At least one of the plurality of reinforcing members 120 may include the second intermediate reinforcing member 125 located perpendicular to the first intermediate reinforcing member 124.

The first intermediate reinforcing member 124 and the second intermediate reinforcing member 125 may further contribute to increasing the structural rigidity of the case 110 through the pair of lateral reinforcing members 121, the top reinforcing member 122, and the bottom reinforcing member 123. This is because an internal side of the case 110 may be more firmly supported through the horizontal and vertical arrangement structure of the reinforcing member 120 coupled to the inner surface 111 of the case 110.

That is, it may be possible to further prevent the case 110 from being bent or twisted during movement of the case 110 through the first intermediate reinforcing member 124 and the second intermediate reinforcing member 125. The first intermediate reinforcing member 124 and the second intermediate reinforcing member 125 may also distribute the load applied to the case 110.

As shown in FIG. 8, the first intermediate reinforcing member 124 may include a C-shaped cross section to more firmly support the inner surface 111 of the case 110, thereby further increasing the structural rigidity of the case 110.

Likewise, the second intermediate reinforcing member 125 may also include a C-shaped cross section, and the second intermediate reinforcing member 125 may be coupled to the first intermediate reinforcing member 124 and the upper reinforcing member 122 to further increase the structural rigidity of the case 110.

Referring to FIGS. 9 and 10 together, the cabinet 100 according to an embodiment of the present disclosure may further include the shelf member 130 having one end inserted into the second intermediate reinforcing member 125 and located in the second direction (x-axis direction). The shelf member 130 may include a shelf surface 131 protruding in the first direction (y-axis direction) on one surface of the shelf member 130.

That is, the shelf member 130 may be inserted into the second intermediate reinforcing member 125 and may support the second intermediate reinforcing member 125, thereby further increasing the structural rigidity of the case 110. The shelf member 130 may distribute the load applied to the case 110.

The above-described plurality of electronic components may be mounted through the shelf surface 131 formed on the shelf member 130, and the plurality of electronic components may be located in the accommodation space and in contact with the reinforcing member 120 and the inner surface 111 of the case 110.

That is, in the cabinet 100 according to an embodiment of the present disclosure, the plurality of reinforcing members 120 having a horizontal and vertical arrangement structure may divide the accommodation space in which the plurality of electronic components are accommodated and may simultaneously function as a support for accommodating the plurality of electronic components. As the plurality of electronic components are accommodated and come into contact with each other, the load applied to the case 110 may be further distributed. As a result, the structural rigidity of the case 110 described above may be further increased.

Referring back to FIG. 9, the cabinet 100 according to an embodiment of the present disclosure may further include an additional reinforcing member 140 located between the plurality of reinforcing members 120 and coupled to the inner surface 111 of the case 110.

In more detail, the additional reinforcing member 140 may include the first additional reinforcing member 141 coupled to the pair of lateral reinforcing members 121 and located in the second direction (x-axis direction). The additional reinforcing member 140 may include the second additional reinforcing member 142 located perpendicular to the first additional reinforcing member 141.

As shown in FIG. 11, the first additional reinforcing member 141 may be bent to be coupled to the inner surface 111 of the case 110 and the pair of lateral reinforcing members 121 and may be coupled thereto through a fastening component such as a bolt. As shown in FIG. 12, the second additional reinforcing member 142 may be bent to be coupled to the inner surface 111 of the case 110 and the first additional reinforcing member 141 and may be coupled thereto through a fastening component such as a bolt.

That is, it may be possible to further prevent the case 110 from being bent or twisted during movement of the case 110 through the first additional reinforcing member 141 and the second additional reinforcing member 142. The first additional reinforcing member 141 and the second additional reinforcing member 142 may also distribute the load applied to the case 110.

In the cabinet 100 according to an embodiment of the present disclosure, the additional reinforcing member 140 may further include a third additional reinforcing member 143 located perpendicular to the first additional reinforcing member 141 and the second additional reinforcing member 142. As described above, the third additional reinforcing member 143 may also distribute the load applied to the case 110, thereby further increasing the structural rigidity of the case 110.

The additional reinforcing member 140 having a horizontal and vertical arrangement structure may divide the accommodation space in which a plurality of electronic components are accommodated and may simultaneously function as a support for accommodating the plurality of electronic components. As the plurality of electronic components are accommodated and come into contact with each other, the load applied to the case 110 may be further distributed. As a result, the structural rigidity of the case 110 described above may be further increased.

In other words, the cabinet 100 according to an embodiment of the present disclosure may support an internal side of the case 110 through a horizontal and vertical arrangement structure of the reinforcing member 120, the shelf member 130, and the additional reinforcing member 140 that are coupled to the inner surface 111 of the case 110. This may prevent the case 110 from being bent, twisted, or damaged by the load applied to the case 110 during movement of the case 110.

Referring to FIGS. 9 and 13 together, in the cabinet 100 according to an embodiment of the present disclosure, the case 110 may include a roof 113 extending from an upper surface of the case 110 and protruding forward. The case 110 may include a rib 114 that protrudes forward from a circumference of a front surface of the case 110. The case 110 may include a door 115 having an upper surface in contact with a lower surface of the roof 113 and inserted into the rib 114.

In particular, as shown in FIG. 13, in the cabinet 100 according to an embodiment of the present disclosure, a front surface of the roof 113 and a front surface of the door 115 inserted into the rib 114 may define the same plane.

In other words, the front surface of the roof 113 and the front surface of the door 115 inserted into the rib 114 may define the same plane, and thus a sense of visual unity may be provided to a user, which has an effect of improving aesthetics.

Referring to FIGS. 9 and 13 together, the cabinet 100 according to an embodiment of the present disclosure may further include a sealing member 150 coupled to the rib 114 along an outer surface thereof and blocks a gap between the rib 114 and door 115 inserted into the rib 114. Here, the sealing member 150 may include, for example, a rubber member including silicon.

This is because, as described above, due to the characteristics of the cabinet 100, which is mainly installed outdoors, the cabinet 100 is exposed to an external environment, and in particular, a device for waterproofing is required to maintain electrical stability and long-term lifespan of the cabinet 100.

Therefore, the cabinet 100 according to an embodiment of the present disclosure may block a gap that may be generated when the door 115 is inserted into the rib 114 through the sealing member 150, thereby ensuring electrical stability through a waterproof structure.

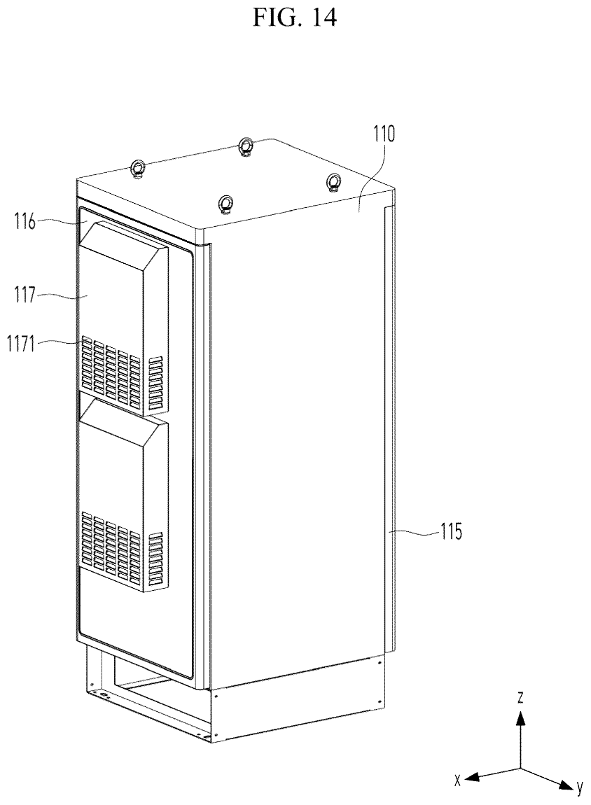

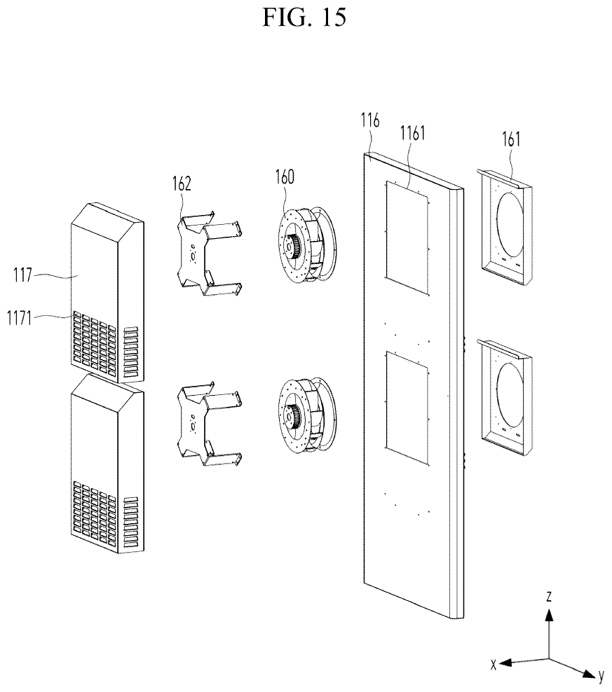

FIG. 14 is a perspective view of the cabinet 100 according to an embodiment of the present disclosure. FIG. 15 is an exploded view of a structure of a rear cover 116 in the cabinet 100 according to an embodiment of the present disclosure.

Referring to FIGS. 14 and 15 together, in the cabinet 100 according to an embodiment of the present disclosure, the case 110 may include the rear cover 116 having an opening 1161 formed therein and an exhaust bracket 117 coupled to the rear cover 116 and covering the opening 1161. Here, the exhaust bracket 117 may include an exhaust hole 1171 that is inclined downward. A plurality of exhaust holes 1171 may be spaced apart from each other and formed on a front surface and a lateral surface of the exhaust bracket 117.

The cabinet 100 according to an embodiment of the present disclosure may further include a blower 160 located inside the exhaust bracket 117 and exhausts heat generated from electronic components mounted in the accommodation space through the exhaust hole 1171.

The cabinet 100 according to an embodiment of the present disclosure may further include a fixing plate 161 coupled to the rear cover 116 and fixing a blower 160 and a fixing bracket 162 coupled to the exhaust bracket 117 and the fixing plate 161 and covering the blower 160.

In more detail, referring to FIG. 15, in the cabinet 100 according to an embodiment of the present disclosure, the blower 160 may be located in the opening 1161 formed in the rear cover 116, and may be inserted into the fixing plate 161. The fixing plate 161 may be coupled to a rear surface of the rear cover 116 and may fix the blower 160.

In the cabinet 100 according to an embodiment of the present disclosure, the fixing bracket 162 may be located in front of the blower 160 located in the opening 1161 of the rear cover 116 and may be coupled to a front surface of the rear cover 116, and thus may cover the blower 160. The exhaust bracket 117 may cover the fixing bracket 162 and may be coupled to the front surface of the rear cover 116.

In the cabinet 100 according to an embodiment of the present disclosure, the exhaust hole 1171 formed in the exhaust bracket 117 may be inclined downward, thereby dissipating heat generated from the electronic components through the blower 160 downward.

As described above with reference to FIGS. 14 and 15, in the cabinet 100 according to an embodiment of the present disclosure, an exhaust structure for dissipating heat generated from the electronic component mounted in the accommodation space may be located at a rear side of the case 110.

This is because, as described above, to ensure an infrastructure for charging electric vehicles, it is necessary to ensure a sufficient space to install charging facilities for electric vehicles, but there are some limits to expanding the installation space in public buildings, park parking lots, highway rest areas, and apartment complexes.

Accordingly, in the cabinet 100 according to an embodiment of the present disclosure, the width of the case 110 in the left and right directions (y-axis direction) may be reduced by locating the above-described exhaust structure at the rear side of the case 110. In other words, the size of the case 110 may be reduced, and this is advantageous in ensuring an installation space, and thus a problem of the limitation of installation space described above may be resolved.

The exhaust bracket 117 with the exhaust hole 1171 formed therein may be hidden from a user view by locating the exhaust structure at the rear side of the case 110. Through this, an effect of improving aesthetics may also be obtained.

Summarizing the above, the cabinet according to the present disclosure may increase the structural rigidity of a case through a reinforcing member coupled to the inner surface of the case. It may be advantageous in ensuring an installation space by reducing the size of a case while improving aesthetics through a shape of a case and rear arrangement of a blower.

The cabinet according to the present disclosure may increase the structural rigidity of the case through a reinforcing member coupled to an inner surface of the case.

The present disclosure provides a cabinet advantageous in ensuring an installation space by reducing the size of the case while improving aesthetics through a shape of a case and rear arrangement of a blower.

It will be appreciated by persons skilled in the art that the effects that could be achieved with the present disclosure are not limited to what has been particularly described hereinabove and other advantages of the present disclosure will be more clearly understood from the above detailed description.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

What is claimed is:

1. A cabinet comprising:
a case having an accommodation space therein and having an open front; and
a reinforcement coupled to an inner surface of the case and configured to increase structural rigidity of the case,
wherein the reinforcement includes:
a pair of lateral reinforcements arranged upright and spaced apart from each other along a first direction;
a top reinforcement disposed at an upper end of the pair of lateral reinforcements; and
a bottom reinforcement disposed at a lower end of the pair of lateral reinforcements.

2. The cabinet of claim 1, wherein the reinforcement has:
a coupling surface in contact with the inner surface of the case; and
a support surface forming a perpendicular angle with the coupling surface and protruding from the inner surface of the case.

3. The cabinet of claim 2, wherein a portion of the reinforcement has a C-shaped cross section.

4. The cabinet of claim 1, wherein the reinforcement is configured as a plurality of reinforcements that are spaced apart from each other along a second direction perpendicular to the first direction and coupled to the inner surface of the case.

5. The cabinet of claim 4, wherein the case has a plurality of fastening grooves on an upper surface thereof that are spaced apart from each other along the first direction and the second direction, and
the plurality of reinforcements are coupled to the inner surface of the case such that the top reinforcement is located at positions corresponding to the plurality of fastening grooves.

6. The cabinet of claim 4, wherein at least one of the plurality of reinforcements includes a first intermediate reinforcement extending parallel to the top reinforcement and the bottom reinforcement between the pair of lateral reinforcements.

7. The cabinet of claim 6, wherein at least one of the plurality of reinforcements includes a second intermediate reinforcement extending perpendicular to the first intermediate reinforcement.

8. The cabinet of claim 7, further comprising a shelf having one end inserted into the second intermediate reinforcement and extending along the second direction.

9. The cabinet of claim 8, wherein the shelf has a shelf surface protruding in the first direction on one surface of the shelf.

10. The cabinet of claim 4, further comprising an additional reinforcement located between the plurality of reinforcements and coupled to the inner surface of the case.

11. The cabinet of claim 10, wherein the additional reinforcement includes:
a first additional reinforcement coupled to the pair of lateral reinforcements and extending along the second direction; and
a second additional reinforcement extending perpendicular to the first additional reinforcement.

12. The cabinet of claim 11, wherein the additional reinforcement further includes a third additional reinforcement extending perpendicular to the first additional reinforcement and the second additional reinforcement.

13. The cabinet of claim 1, wherein the pair of lateral reinforcements, the upper reinforcement and the lower reinforcement are coupled to each other through bolt fastening.

14. The cabinet of claim 1, wherein the case includes:
a roof extending from an upper surface of the case and protruding forward;
a rib protruding forward from a periphery of a front surface of the case; and
a door having an upper surface in contact with a lower surface of the roof and inserted into the rib.

15. The cabinet of claim 14, wherein a front surface of the roof and a front surface of the door define an identical plane.

16. The cabinet of claim 14, further comprising a seal coupled to the rib along an outer surface thereof and configured to block a gap between the rib and the door.

17. The cabinet of claim 1, wherein the case includes:
a rear cover having an opening; and
an exhaust bracket coupled to the rear cover and covering the opening,
wherein the exhaust bracket has an exhaust hole that is inclined downward.

18. The cabinet of claim 17, further comprising a blower located inside the exhaust bracket and configured to exhaust heat generated from an electronic component mounted in the accommodation space through the exhaust hole.

19. The cabinet of claim 18, further comprising:
a fixing plate coupled to the rear cover and fixing the blower; and
a fixing bracket coupled to the exhaust bracket and the fixing plate and covering the blower.

20. The cabinet of claim 17, wherein the exhaust hole is configured as a plurality of exhaust holes spaced apart from each other on a front surface and a lateral surface of the exhaust bracket.
